(19) United States
(12) Patent Application Publication
(10) Pub. No.: US 2011/0016632 A1
(43) Pub. Date: Jan. 27, 2011

(54) Adjustable storage system

(76) Inventor: Steven L. Hopf, Riverside, CA (US)

Correspondence Address: Steven Hopf, Suite C, 555 Main Street, Riverside, CA, 92501, US

(21) Appl. No.: 12/800,544

(22) Filed: May 18, 2010

Related U.S. Application Data
(60) Provisional application No. 61/271,642, filed on Jul. 24, 2009.

(51) Int. Cl. A47B 23/02; A61G 7/05

(52) U.S. Cl. 5/503.1; 211/86.01

(57) ABSTRACT

An adjustable storage system may include a storage tray with a support surface and a clamp mount including a clamp axis. The clamp mount may be coupled to the storage tray with the clamp axis positioned substantially parallel to the support surface. The storage system may also include a clamp, rotatably coupled to the clamp mount about the clamp axis, whereby the tray may be adjustably positioned relative to the clamp about the clamp axis. When the storage system is secured to a frame, such as a bed rail, by use of the clamp, the support surface of the tray may be positioned substantially parallel to a reference plane, such as the floor, regardless of the angle of inclination of a frame relative to the reference plane. This enables stable support of objects supported by the tray when the bed is inclined or flat.

### CROSS-REFERENCE TO RELATED APPLICATION DATA

Priority is claimed under 35 U.S.C. §119(e) to U.S. Provisional Application No. 61/271,642, filed on Jul. 24, 2009, which is incorporated by reference herein.

### FIELD OF THE INVENTION

The present invention generally relates to storage service devices and, more particularly, to patient care accessories associated with a hospital bed or other support structure.

### BACKGROUND OF THE INVENTION

Storage devices are useful in many applications. Any number of situations where someone may be located in a seat, chair or bed for a prolonged period, a storage system may be desired. From a cup holder while driving to a nightstand near the bed, devices to support personal items are desirable in many forms.

One of the most useful applications for a storage device would be for a patient in a hospital bed. In this situation the user may spend long hours, awake and in need of service items such as a call button, water glass, television remote, and so on. Traditional night stands may be inadequate in that the patient's dexterity may be compromised due to the medical procedures or recovery from some other trauma, thus placing the patient in the hospital or rehabilitation setting. For example a person recovering from shoulder surgery may not be able to lean over to reach a bottle of water. In this case, bringing the bottle to the patient is important.

With any storage system stability is important. An unstable surface may not be suited for supporting an object. That said, many beds, chairs and especially hospital beds are adjustable, and therefore change height or angle to more comfortable accommodate the needs of the patient. If a storage device is attached to the frame or rail of the bed, and the bed changes angle (inclines or declines) the storage system may move with it. Current storage systems fail to account for this change and must be removed, replaced and repositioned each time the bed is altered. If not, the contents of the storage system may end up on the floor or in the bed. A call button that cannot be reached by the patient because it is on the floor may be just as dangerous as a bottle of water spilled on the slick hard floor of a hospital room. Each of these is not desirable and potentially dangerous to the patient as well as visitors and hospital personnel.

It should, therefore, be appreciated that there is a need for a storage system that may be mounted onto a hospital bed and easily adjusted to accommodate the angle of the bed. The present invention fulfills this need and others.

### SUMMARY OF THE INVENTION

The present invention provides an adjustable storage system which may include a storage tray with a support surface and a clamp mount including a clamp axis. The clamp mount may be coupled to the storage tray with the clamp axis positioned substantially parallel to the support surface. The storage system may also include a clamp, rotatably coupled to the clamp mount about the clamp axis, whereby the tray may be adjustably positioned relative to the clamp about the clamp axis.

The storage tray may also include one or more side walls, positioned substantially orthogonal to the support surface. The clamp mount may be coupled to the side wall of the storage tray, wherein the side wall may include a slot. The support surface may include an access hole adapted to receive a cord, tube or other tethering device. The storage tray may also include a side wall positioned substantially orthogonal to the support surface. The side wall may include a slot that is continuous with the access hole in the support surface.

The clamp may be comprised of a first clamp half spaced apart from a second clamp half and a knob with a threaded shaft connecting the first clamp half to the second clamp half, whereby rotation of the knob alters the space between the first clamp half and the second clamp half. The clamp assembly may also include a guide rod coupled to the first clamp half and received by the second clamp half, thereby restricting the movement of the first clamp half relative to the second clamp half to a common plane of movement.

The storage tray may include more than one cavity, each cavity providing a support surface and at least one side wall. The storage tray may include two cavities, each with a side wall and each with a slot.

An exemplary method for enabling storing of items for use with a hospital bed or other supporting device including a side rail, the method including a tray with the elements as described, including a clamp mount may be coupled to the storage tray with the clamp axis positioned substantially parallel to the support surface. The method may include the steps of: securing the clamp to the side rail of the bed; rotating the tray such that the support surface is at an angle relative to a reference plane; altering the angle of the side rail of the bed relative to the reference plane; and rotating the tray relative to the side rail to realign with the angle relative to the reference plane.

For purposes of summarizing the invention and the advantages achieved over the prior art, certain advantages of the invention have been described herein above. Of course, it is to be understood that not necessarily all such advantages can be achieved in accordance with any particular embodiment of the invention. Thus, for example, those skilled in the art will recognize that the invention can be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following description of the preferred embodiments and drawings, the invention not being limited to any particular preferred embodiment(s) disclosed.

### BRIEF DESCRIPTION OF THE DRAWINGS

Embodiments of the present invention will now be described, by way of example only, with reference to the following drawings, in which:

FIG. 1 is an isometric view of a storage system with a storage tray and a clamp movably mounted to the clamp tray and produced in accordance with the present invention.

FIG. 2 is an isometric detail view shown along line 2-2 of the clamp of the storage system of FIG. 1.

FIG. 3 is a top view of the storage device of FIG. 1

FIG. 4 is a section view of the storage tray of FIG. 3 cut along line 4-4.

FIG. 5 is a side view of the storage system of FIG. 1.

FIG. 6 is an isometric view of the storage system of FIG. 1 with the clamp in a rotated position.

FIG. 7 is an isometric view of the storage system of FIG. 1, shown secured to a side rail of a bed and holding typical items, the bed shown in a flat position.

FIG. 8 is an isometric detail view of the storage system of FIG. 7 shown along line 8-8.

FIG. 9 is an isometric view of the storage system as shown secured to a side rail of a bed and holding typical items as in FIG. 7, here the bed shown in an inclined position.

FIG. 10 is an isometric detail view of the storage system of FIG. 9 shown along line 10-10.

### DETAILED DESCRIPTION OF THE INVENTION

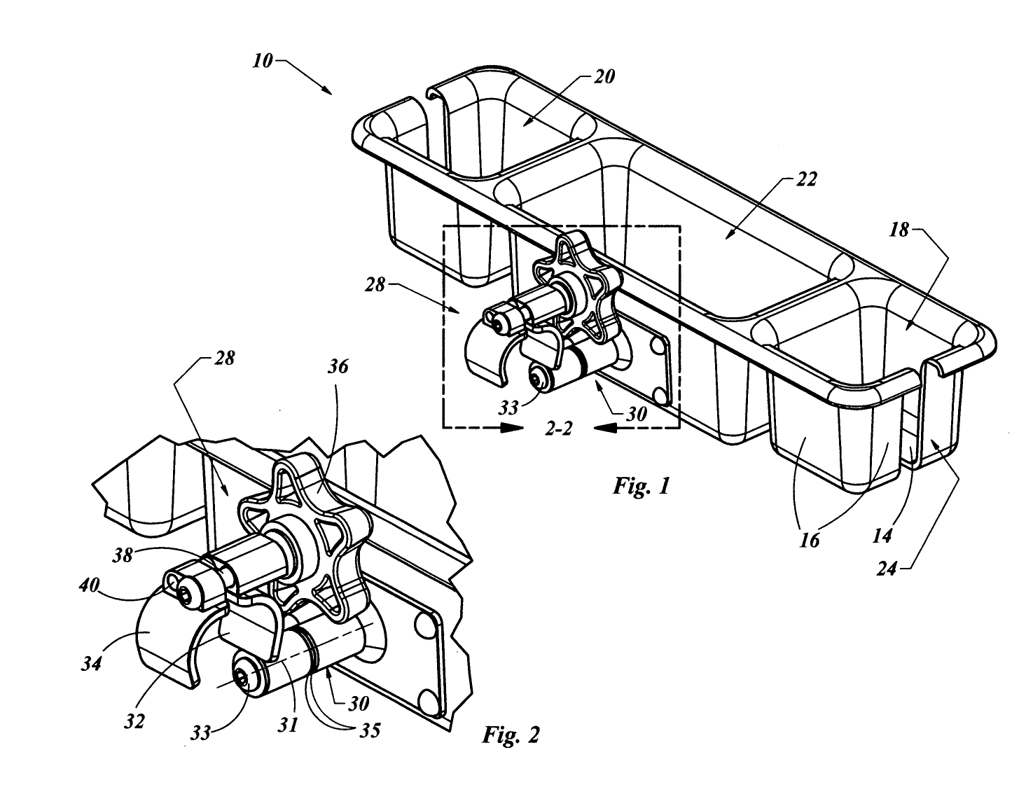

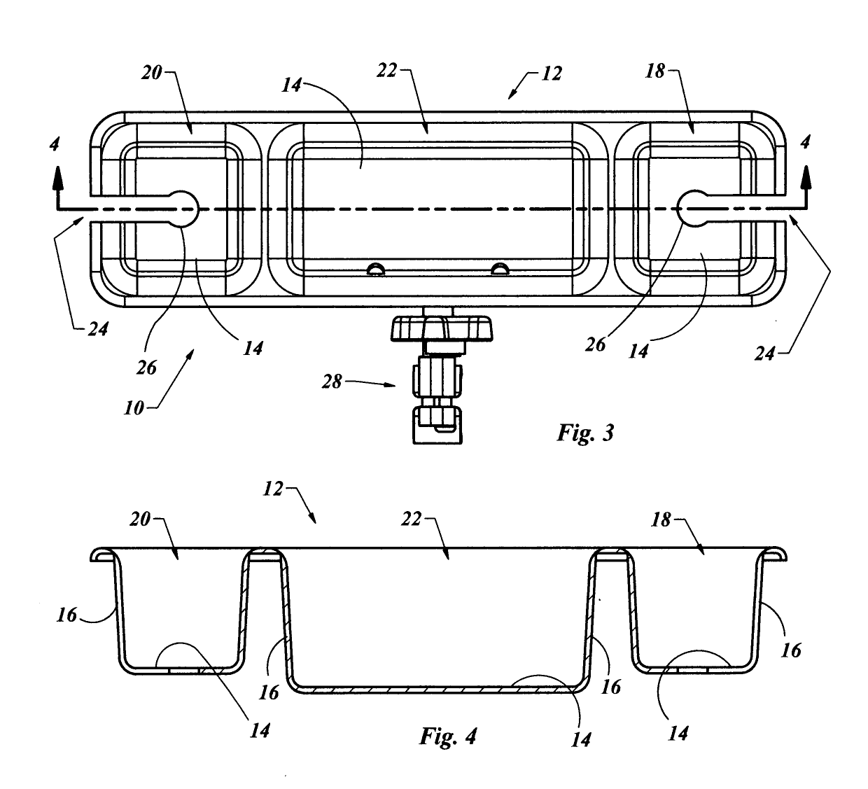

With reference to the illustrative drawings, and particularly to FIGS. 1-5, there is shown an adjustable storage system 10. The storage system 10 may include a storage tray 12, which may include a support surface 14 and one or more side walls 16. In this embodiment of the invention, there are three distinct cavities, the first cavity 18 and the second cavity 20 being smaller and distally positioned relative to a larger, and more centrally positioned, third cavity 22. This configuration is not considered critical to the novelty of the invention, and therefore may be altered according to design needs. One large cavity with a single support surface 14 may be used. The side walls 16 in this form of the invention are shown to be in a substantially square orientation with a slightly smaller dimension at the support surface 14 end (bottom) relative to the open end at the top. This draft angle is provided in that the storage tray 12 may be produced from a plastic or other molded material, and the draft angle facilitates the removal of the part from the mold. In addition, this angle enables multiple storage trays 12 to be nested together when stacked for storage, thereby reducing storage and shipping costs. Though this form of the storage tray 12 of the invention may be preferable in many situations, a single cavity with the side wall 16 provided in an arced or oval shape may also be provided, thereby creating a single continuous side wall 16 though still encompassing the peripheral edge of the storage tray 12. These are all design considerations considered to be included in the scope of the present invention.

The support surface 14 of the storage tray 12 is provided as a structural element to support items placed on the support surface 14, similar to the surface of a table or desk. A support surface 14 may also be provided in the second cavity 20 and the third cavity 22 of the storage tray 12 in addition to the first cavity 18. Where more than one cavity is provided, each cavity may include a support surface 14 as shown. The support surface 14 of each cavity may be coplanar but, as shown here, it is not necessary.

A slot 24 may be provided in one or more side walls 16 and may be continuous with an access hole 26 in one or more support surface 14. The slot 24 may be in any or all of the side walls 16 of the storage tray 12. The slot 24 and the access hole 26 may be used alone or in combination to provide access to electrical cords, tubes or any other tethering device, such as a call button, attached to an item to be placed in the storage tray 12. Details to the function of the slot 24 and the access hole 26 will be presented in more detail further in this disclosure.

A clamp 28 is provided and coupled to a clamp mount 30, which may be mounted to a side wall 16 of the storage tray 12. The clamp 28 may be received by the clamp mount 30, which may include a clamp axis 31 about which the clamp 28 may rotate. The clamp 28 may be coupled to the clamp mount 30 in a manner such that the rotation of the clamp 28 with respect to the clamp mount 30 is restricted due to friction between contact surfaces of the clamp 28 and the clamp mount 30. The frictional force may be adjusted by the tension in a clamp screw 33, which may be used to secure the clamp 28 to the clamp mount 30 about the clamp axis 31. The friction between the parts may be due to the normal force between the clamp 28 and the clamp mount 30. It may be desired to use a bushing 35 or a pair of bushings 35, one associated with the clamp 28 and the other bushing 35 with the clamp mount 30. The bushings 35 may include a flange to provide a bearing surface with which to provide the frictional forces. In a similar manner the structural material of the clamp 28 and clamp mount 30 may also be used as a bearing surface one to the other. Each has advantages. The primary advantage to the use of bushings 35 is this may be a replaceable part that as it wears, it may be replaced without damaging the structure of the clamp 28 or clamp mount 30.

The clamp 28 may include a first clamp half 32 spaced apart from a second clamp half 34 and a knob 36 with a threaded shaft 38 connecting the first clamp half 32 to the second clamp half 34. The knob 36 may be coupled to the threaded shaft 38 so that rotation of the knob 36, relative to the first clamp half 32 or the second clamp half 34, enables the distance between the first clamp half 32 and the second clamp half 34 to be modified. By doing so, a rail or other structural element may be releasably clamped by “pinching” it between the first clamp half 32 and second clamp half 34 by rotation of the knob 36. The knob 36 may otherwise include a female threaded portion connecting the knob 36 to the second clamp half 34 with the first clamp half 32 captured there between. The knob 36 may include a female threaded portion and the threaded shaft 38 may be fixed to the second clamp half 34. Therefore the knob 36 may include a threaded portion that is female and receives a mating thread of the threaded shaft 38 associated with the second clamp half 34 or as previously stated, the threaded shaft 38 may be associated with the knob 36 and a female threaded portion may be included with the second clamp half 34. In both conditions, the first clamp half 32 may be captured between the knob 36 and the second clamp half 34.

The first clamp half 32 may be desired to remain coplanar with the second clamp half 34. If the only common support element coupling the first clamp half 32 with the second clamp half 34 is the threaded shaft 36, the first clamp half 32 may be able to rotate about the threaded shaft 36 relative to the second clamp half 34. In that it may be desired to prevent this rotation, a guide rod 40 may be provided that is fixed to either the first clamp half 32 or the second clamp half 34, but not both. If the guide rod 40 is fixed to the second clamp half 34, the guide rod 40 would be free to move relative to and guided by the first clamp half 32. This combination may provide a guide to allow the space between the first clamp half 32 and the second clamp half 34 to be varied by movement of the knob 36, but yet provide the first clamp half 32 and the second clamp half 34 to move in a common plane.

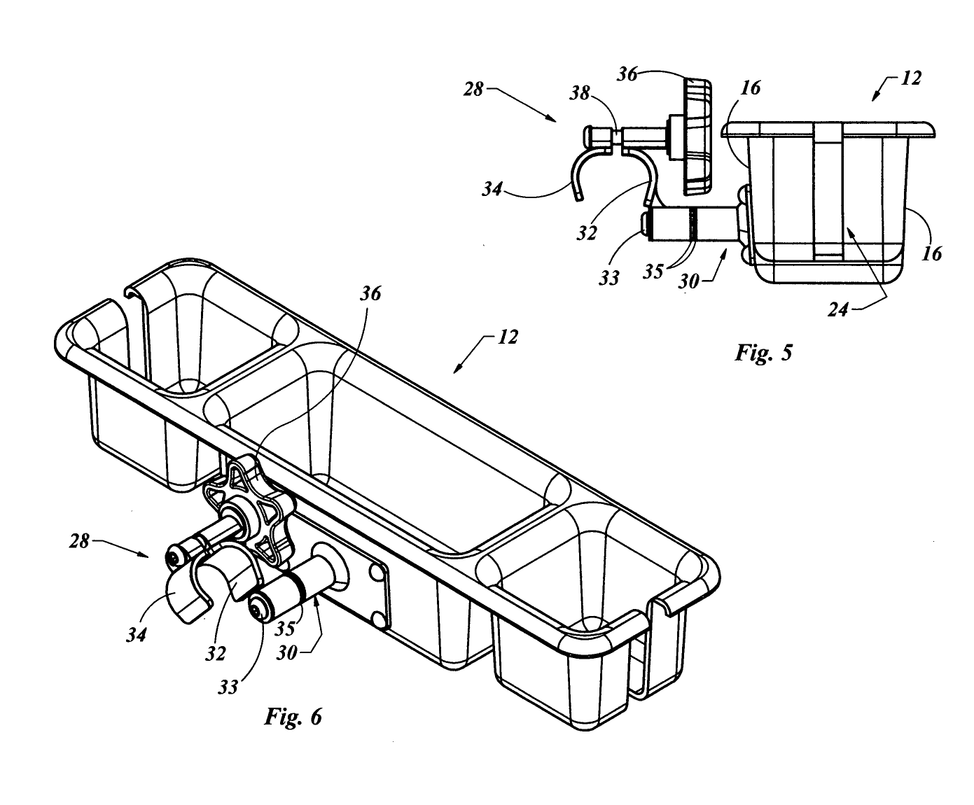

With reference to FIG. 6, the clamp 28 is shown as it may be rotatably mounted to the clamp mount 30, enabling the clamp 28 to be rotated with respect to the storage tray 12. Movement of the clamp 28 in this manner enables the storage system to maintain a specified orientation regardless of the support structure.

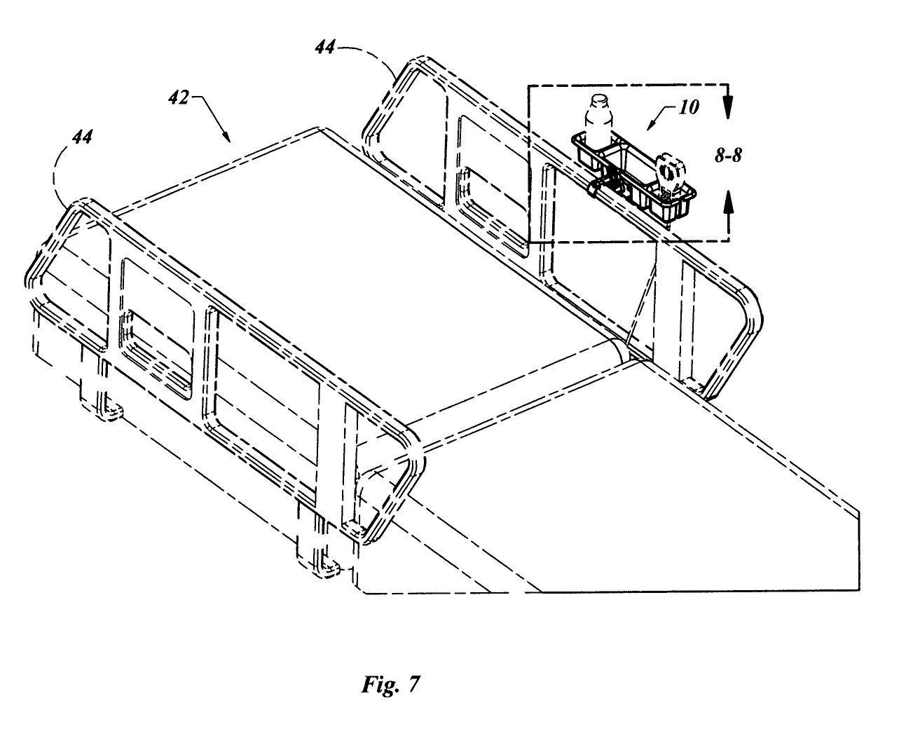

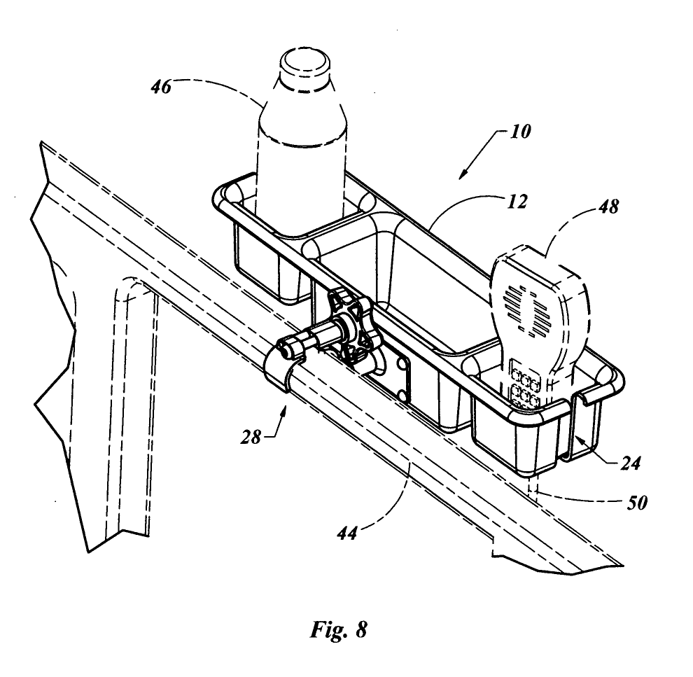

An example of the use of the storage system 10 is shown in FIGS. 7-10. In FIG. 7 a hospital bed 42 with a side rail 44 on each side of the bed 42 is shown in a flat position. The storage system 10 may be mounted onto the side rail 44 in a manner shown, with some objects supported by the storage system 10. A more detailed view of the storage system 10 is shown in FIG. 8. The clamp 28 may be secured to the side rail 44, and the storage tray 12 may be positioned substantially parallel to the side rail 44. Items commonly needed such as a bottle 46 and a call button 48 are shown as examples of items that may be stored in the storage tray 12. The slot 24 allows access for the cord 50 of the call button 48, so that the call button 48 can be positioned upright with the cord 50 extending out the bottom of the storage tray 12. Without the slot 24 and hole 26 (not shown in this view) the cord 50 would have to be doubled back on itself and stuffed into the storage tray 12, making it unstable and therefore more likely to fall out. If the call button 48 fell, it may make the call button 48 difficult or impossible to reach in the case of an emergency where the patient is unable to get out of bed to retrieve the call button 48. The use of the slot 24 and hole 26 enable a secure and stable support for the call button by gently “capturing” the body of the call button 48 in the storage tray 12 and the cord 50 through the slot 24 and into the hole 26. The patient may still be able to grasp and move the call button 48 while it is in the storage tray 12, but it is less likely to be accidently dropped by a patient with limited cognizant faculties as the cord 50 acts as a tether to help support the call button 48 in the storage tray 12.

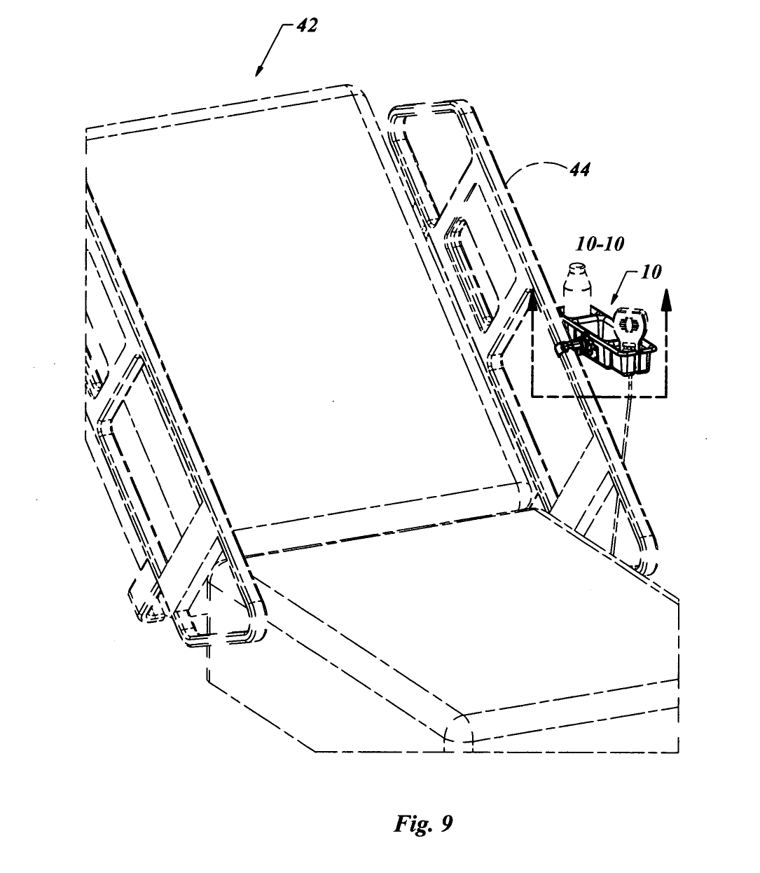

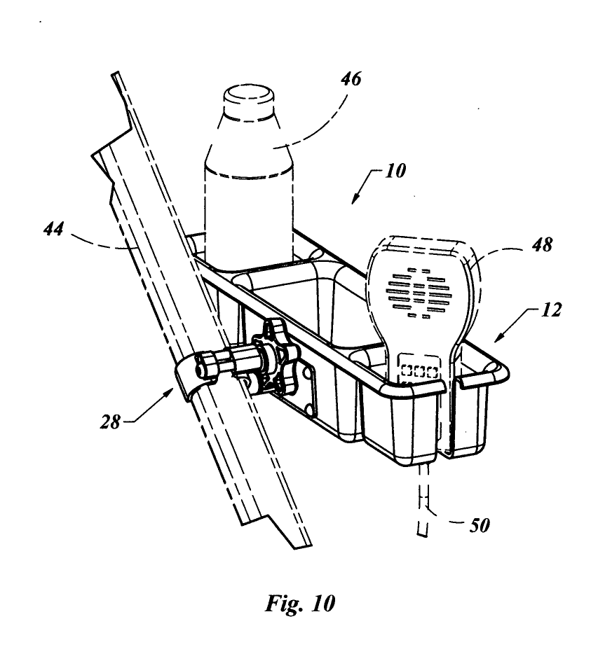

With reference to FIGS. 9 and 10, the bed 42 has been raised to a sitting position. This may be common with a patient that desires to converse with visitors, read or watch television. In this position of the bed 42, the side rails 44 are also inclined with respect to the horizontal. A typical tray that would attach directly to the side rail 44 would incline with the bed 42 and may spill the contents of the tray when in an elevated position. The storage system 10 as disclosed enables the clamp 28 to be rotated with respect to the storage tray 12 so that it can remain in a substantially horizontal position, if desired, or any other position. This enables the contents of the storage tray 12 to not spill, or at least to reduce the likelihood of the contents spilling out regardless of the angle of the bed 42 and with it the angle of the side rail 44. The friction contact between the clamp 28 and the clamp support 30 enable the storage tray 12 to be rotated into any position and maintained in that position even if this angle is not perfectly parallel to the horizontal. Also, if the storage tray 12 is loaded with a heavier item on one side relative to the other side, the storage tray 12 may tip without the desire of the user in the absence of any friction or other locking system.

The foregoing detailed description of the present invention is provided for purposes of illustration, and it is not intended to be exhaustive or to limit the invention to the particular embodiment shown. The embodiments may provide different capabilities and benefits, depending on the configuration used to implement key features of the invention.

What is claimed is:

1. An adjustable storage system, comprising:
a storage tray including a support surface;
a clamp mount including a clamp axis, the clamp mount coupled to the storage tray with the clamp axis substantially parallel to the support surface; and
a clamp, rotatably coupled to the clamp mount about the clamp axis, whereby the tray may be adjustably positioned relative to the clamp about the clamp axis.

2. The storage system according to claim 1, wherein the storage tray includes a side wall, substantially orthogonal to the support surface.

3. The storage system of claim 2, wherein the clamp mount is coupled to the side wall of the storage tray.

4. The storage system of claim 2, wherein the side wall includes a slot.

5. The storage system of claim 1, wherein the support surface includes an access hole.

6. The storage system of claim 5, further comprising a side wall orthogonal to the support surface, the side wall including a slot that is continuous with the access hole.

7. The storage system of claim 1, wherein the clamp is comprised of a first clamp half spaced apart from a second clamp half and a knob with a threaded portion connecting the first clamp half to the second clamp half, whereby rotation of the knob alters the space between the first clamp half and the second clamp half.

8. The storage system of claim 7, further comprising a guide rod coupled to the first clamp half and received by the second clamp half, thereby restricting the movement of the first clamp half relative to the second clamp half to a common plane.

9. The storage system of claim 1, wherein the storage tray includes more than one cavity, each cavity providing a support surface and at least one side wall.

10. The storage system of claim 9, wherein the storage tray includes two cavities each with a side wall including a slot.

11. The storage system of claim 1, further comprising a clamp screw to secure the clamp to the clamp mount, thereby providing a frictional coupling of the clamp mount to the clamp.

12. An adjustable storage system, comprising:
a storage tray including a support surface; and
a clamp means, including a clamp axis substantially parallel to the support surface of the storage tray, the clamp means coupled to the storage tray and adapted for rotational articulation with the storage tray about the clamp axis.

13. The storage system according to claim 12, wherein the storage tray includes a side wall, substantially orthogonal to the support surface.

14. The storage system of claim 13, wherein the clamp means is coupled to the side wall of the storage tray.

15. The storage system of claim 13, wherein the side wall includes a slot.

16. The storage system of claim 12, wherein the support surface includes an access hole.

17. The storage system of claim 16, further comprising a side wall orthogonal to the support surface, the side wall including a slot that is continuous with the access hole.

18. The storage system of claim 12, wherein the clamp means is comprised of a first clamp half spaced apart from a second clamp half and a knob with a threaded portion connecting the first clamp half to the second clamp half, whereby rotation of the knob alters the space between the first clamp half and the second clamp half.

19. The storage system of claim 18, further comprising a guide rod coupled to the first clamp half and received by the second clamp half, thereby restricting the movement of the first clamp half relative to the second clamp half to a common plane.

20. The storage system of claim 12, wherein the storage tray includes more than one cavity, each cavity providing a support surface and at least one side wall.

21. The storage system of claim 20, wherein the storage tray includes two cavities each with a side wall including a slot.

22. A storage system including a tray with a support surface, the system adapted for use with a hospital bed, the improvement including:
a clamp means coupled to the storage tray, whereby movement of the storage tray relative to the clamp means is restricted to movement in a plane substantially perpendicular to the support surface of the storage tray.

23. A method of storing items for use with a hospital bed including a side rail, the method including a tray with a support surface and a clamp including a clamp axis substantially parallel to the support surface of the storage tray, the clamp coupled to the storage tray and adapted for rotational articulation with the storage tray about the clamp axis, the method of storing including the steps of:
securing the clamp to the side rail of the bed;
rotating the tray such that the support surface is at an angle relative to a reference plane;
altering the angle of the side rail of the bed relative to the reference plane; and
rotating the tray relative to the side rail to realign with the angle relative to the reference plane.
